(19) United States
(12) Patent Application Publication
(10) Pub. No.: US 2008/0242544 A1
(43) Pub. Date: Oct. 2, 2008

(54) Phytoactive Composition

(76) Inventors: Stephen Craig Duckham, Newton-Le-Willows (GB); Lee Hinds, Manchester (GB); Gordon Nelson, Cheshire (GB)

Correspondence Address: MORRISON & FOERSTER LLP, 12531 HIGH BLUFF DRIVE, SUITE 100, SAN DIEGO, CA, 92130-2040, US

(21) Appl. No.: 11/587,615

(22) PCT Filed: Apr. 27, 2005
(86) PCT No.: PCT/GB05/01607

§ 371 Date: Jan. 16, 2008

(30) Foreign Application Priority Data
Apr. 27, 2004 (GB) 0409375.3

(51) Int. Cl. A01N 63/04; A01N 25/28; A01P 13/00; A01P 13/02

(52) U.S. Cl. 504/103; 504/117

(57) ABSTRACT

The present invention relates to compositions comprising a phytoactive compound and methods comprising the use of such compositions.

The present invention relates to compositions comprising a phytoactive compound and to methods comprising the use of such compositions.

A variety of herbicides have been used to kill or control unwanted plants (weeds) in crop fields, orchards etc. Typically, these herbicides are applied to the soil (pre-emergence) or onto the plants (post-emergence). Herbicides are expensive, and their use may result in unintended consequences such as groundwater contamination, crop damage, environmental damage, spray drift, and human and animal health concerns.

Typically, when a composition is applied to a plant, e.g. foliage, only a small portion of the amount of composition applied reaches sites of action in the plant where a desired biological activity of the exogenous chemical substance can be usefully expressed. There is therefore a need in agriculture to enhance the efficiency of delivery of exogenous chemical substances to their sites of action in plants, e.g. foliar-applied substances, and also to enhance the biological effectiveness of the exogenous chemical substance for the purpose for which the exogenous chemical substance is used.

It is difficult to ensure in advance those conditions where good biological effectiveness will be obtained, partly because so many factors influence efficiency of delivery. These factors include weather (temperature, relative humidity, precipitation, wind. etc.) preceding, during and following application; soil conditions (fertility. aeration. etc.); plant development stage; health; equipment-related inaccuracies in application; and, other factors. Therefore, to help ensure reliable or consistent biological effectiveness of a foliar-applied exogenous chemical substance, the user typically applies the substance at a higher rate than is truly necessary in the majority of situations.

The use of herbicides can result in considerable damage also being caused to cultivated plants, for example in dependence upon the concentration of the herbicide and the mode of its application, the cultivated plant, the nature of the soil and the climatic conditions, such as period of exposure to light, temperature and amounts of precipitation.

Post-emergent herbicides are generally slow acting and usually take days or even weeks to show a visual effect on the weeds and grasses to which they have been applied. This is undesirable and there is a need to improve the efficacy of such herbicides. In addition, there is a need to develop a means delivering active ingredients which requires less of the phytoactive substance, such as a herbicide, to be employed. The reduction in the amount of the eg. herbicidal active ingredient is desired since such chemicals are generally toxic and harmful to the environment.

It is an object of the present invention to overcome or alleviate one or more of the problems associated with the prior art.

In accordance with a first aspect of the present invention there is provided a composition comprising at least one phytoactive compound and an encapsulating adjuvant, wherein the adjuvant comprises a fungal cell or fragment thereof.

The inventors of the present invention have surprisingly discovered that the encapsulation by a fungal cell or fragment thereof as an adjuvant not only increases the efficacy of the phytoactive compound but also improves the selectivity of the phytoactive compound by limiting or preventing the toxicity effects on cultivated plants, for example crops. The present invention thus provides means for increasing the bioavailability of phytoactive compounds by encapsulating the compound in an adjuvant.

The term ‘phytoactive compound’ as used herein is meant to include any compound capable of antagonizing or augmenting plant metabolism such as herbicidal compounds, safeners, growth regulators, such as growth promoters, etc.

The present invention provides compositions having improved bioavailability as a result of targeted delivery to the plant. Adhesion of the adjuvant to leaf surfaces helps deliver the phytoactive compound where it is required. In addition, this provides reduced runoff, and improved rain fastness compared to water soluble herbicides thus providing a more environmentally benign solution to administering a phytoactive compound.

The present invention also negates the need to synthesise water soluble analogues of lipophilic pesticides. Furthermore, selectivity of action of the phytoactive compound is provided by preventing phytotoxicity effects on non-weed species. There is also potential for reduced drift in field applications of the composition owing to the particulate nature of the adjuvant. Thus the present invention gives rise to more effective crop management strategies.

The adjuvant is capable of antagonising the damaging action of the certain phytoactive compounds, such as a herbicidal compound, on a cultivated plant, that is to say of protecting the cultivated plant against the phytotoxic action of the e.g. herbicidal compound, while the herbicidal action on the weeds to be controlled is virtually unimpaired. The present invention provides a selective phytoactive composition for controlling for example; broadleaved weeds in cereal crops, especially in crops, which composition comprises a phytoactive compound and an adjuvant which enhances the bioavailability of the phytoactive compound and protects the cultivated plants, but not the weeds, from the action of the phytoactive compound. Thus in the case of a herbicide, the phytotoxic effects thereof on a crop are reduced.

The fragment of fungal cell may comprise a fungal cell wall, such as a ghost cell, or a part thereof.

Encapsulated compounds are described in WO 00/69440.

The term “herbicidal compound” as used herein is meant to include any compound capable of adversely affecting normal functioning of a weed.

The phytoactive compound may be lipophilic or may comprise a lipophilic moiety. Preferably, the phytoactive compound is lipophilic or substantially lipophilic. The term ‘substantially lipophilic’ as used herein is meant to include those compounds having lipophilic and lipophobic moieties wherein the lipophilic moiety is predominant.

The phytoactive compound may be lipid soluble.

The phytoactive compound may be derived from a lipophobic compound and which is made lipophilic by chemical modification, such as for example esterification, the addition of an alkyl group etc. without substantially compromising efficacy of the phytoactive compound. Hydrophilic compounds may be rendered lipophilic by pH adjustment thus improving their suitability for encapsulation.

The phytoactive compound may further comprise a carrier. For example, in one embodiment, the phytoactive compound is a crystalline solid dissolved in an organic solvent carrier. Thus, the carrier facilitates encapsulation of the phytoactive compound.

Herbicides are generally classified into two groups: those having significant foliar use and those primarily applied into the soil. Herbicides with significant foliar use, generally described as post-emergent herbicides, are further divided into three major categories based on translocation patterns and initial plant symptoms: (a) translocated herbicides showing initial symptoms on new growth; (b) translocated herbicides showing initial symptoms on older growth; and (c) non-translocated herbicides showing initial localized injury. Each of these categories may further be subdivided according to herbicidal mode of action, i.e., auxin-type growth regulators; aromatic amino acid inhibitors; branched-chain amino acid inhibitors; carotenoid pigment inhibitors; lipid biosynthesis inhibitors; organic arsenicals; photosynthesis inhibitors; Photosystem I (PSI) energized cell membrane destroyers; protoporphyrinogen oxidase inhibitors; and glutamine synthesis inhibitors.

Illustrative categories and specific examples of herbicidal compounds useful in conjunction with the present invention include any one or more of the following:

Phenoxy acids or esters; MCPA ((4-chloro-2-methylphenoxy)acetic acid), MCPA esters for example: MCPA-butoxyethyl [19480-43-4]; MCPA-butyl [1713-12-8]; MCPA-2-ethylhexyl [29450-45-1]; MCPA-isobutyl [1713-11-7]; MCPA-iso-octyl [26544-20-7]; MCPA-isopropyl [2698-40-0]; and MCPA-methyl [2436-73-9]; MCPA-thioethyl [25319-90-8]; any one or more of the compounds listed in tables 4, 5 and/or 6. Other examples of actives are well known to a person skilled in the art.

Illustrative categories and specific examples of growth regulating compounds useful in conjunction with the present invention include any one or more of the following: 1-naphthylacetic acid, 2-naphthyloxyacetic acid, ethyl 1-naphthylacetate and 2-(1-naphthyl)acetamide.

Illustrative categories and specific examples of safener compounds useful in conjunction with the present invention include any one or more of the following: furilazole and flurazole.

The phytoactive compound preferably has a positive partition coefficient (LogP_{o/w}) greater than 0.1, more preferably in the range 0.1-10, even more preferably, 0.5-10, even more preferably still 0.5-7.0, most preferably 2.0-7.0.

The phytoactive compound may have a pH in the range pH1.0-12.0, preferably pH4-9.

Preferably the phytoactive compound is not acidic or basic in nature but if it is acid it should have a pKa between 2.0-7.0, most preferably between 4.0-7.0. If basic it should have a pKa between 7.0-12, most preferably between 7.0-10.0.

Preferably, the phytoactive compound is present in an amount from 1-50 g/100 g of product.

Preferably the phytoactive compound is a liquid at s.t.p. (20° C., 1 atm.) or dissolved in an organic solvent. Preferably the phytoactive agent is soluble in the solvent at a level above 10 g/l, preferably above 100 g/l, most preferably above 500 g/l.

This is to facilitate encapsulation within the adjuvant. The phytoactive compound may be liquid in its normal state or it may be a solid, in which case it is preferably dissolved or micro-dispersed in a carrier such as an organic solvent which is lipid soluble. Suitable carriers include any one or more of the following:
a) primary alcohols within the range C4 to C12, such as nonanol and decanol;
b) secondary and tertiary alcohols;
c) glycols, such as diethylene glycol;
d) esters, particularly esters having straight carbon chains greater than 2 and less than or equal to 12, for example, ethyl butyrate, triacetin;
e) aromatic hydrocarbons such as xylene and acetopenone;
f) any aromatic lipophilic oil with no straight chain branch greater than 12 carbons; and
g) carboxylic acids between C3 and C12

The carrier is preferably non-miscible with water. Preferably, the carrier is organic and has a molecular weight in the range of 100-700. More preferably, the carrier is not miscible with water.

In one embodiment, the carrier comprises a mixture of 2 or more solvents. Preferably, at least one of the solvents is not miscible with water. More preferably, the mixture of solvents forms a homogeneous liquid mixture.

The carrier may comprise any one or more selected from the following: Alkanes, alkenes, alkynes, aldehydes, ketones, monocyclics, polycyclics, heterocyclics, monoterpenes, furans, pyrroles, pyrazines, azoles, carboxylic acids, benzenes, alkyl halides, alcohols, ethers, epoxides, esters, fatty acids, and essential oils.

Preferably, the carrier is selected for a particular phytoactive compound. For example, phytotoxic carriers are less appropriate to growth regulator applications.

The carrier may comprise any one or more of the following:

TABLE 1
carriers

| Name | logP(o/w) |
|---|---|
| 1-(2-aminophenyl)-1-ethanone | 1.1 |
| acetophenone (1-phenyl-ethanone) | 1.7 |
| alpha-pinene | 3.9 |
| alpha-terpineol | 1.7 |
| benzene | 2.0 |
| benzonitrile | 1.5 |
| benzyl alcohol | 1.1 |
| bromobenzene | 2.9 |
| 1-butanethiol | 2.1 |
| butylbenzene | 3.9 |
| caryophyllene | 6.0 |
| chlorobenzene | 2.6 |
| cyclohexane | 3.2 |
| cyclohexanol | 1.6 |
| decane | 5.3 |
| decanoic acid | 3.5 |
| 5-decanolide | 3.1 |
| decyl alcohol | 3.8 |
| diallyl disulfide | 3.1 |
| 1,3-difluorobenzene | 2.4 |
| dimethyl adipate | 1.4 |
| 3,4-dimethyl phenol | 2.2 |
| 3,7-dimethyl-2,6-octadienal | 1.7 |
| 1,5-dimethyl-1-vinyl-4-hexenyl acetate | 2.7 |
| 1,5-dimethyl-1-vinyl-4-hexenyl hexanoate | 4.5 |
| dipropyl disulfide | 3.7 |
| (+−)-5-dodecanolide | 4.0 |
| dodecanoic acid | 4.4 |
| epibromohydrin | 2.1 |
| ethylbenzene | 3.0 |
| ethyl (E)-3-hexenoate | 1.7 |
| 4-ethyl-2-methoxy phenol | 2.4 |
| ethyl 3-methylbutanoate | 1.8 |
| ethyl hexanoate | 2.3 |
| ethyl nonanoate | 3.7 |
| fluorobenzene | 2.2 |
| heptane | 3.8 |
| 1-heptanol | 3.1 |
| heptan-2-one | 1.9 |
| hexane | 3.3 |
| 1-hexanol | 2.7 |
| (Z)-3-hexenyl 2-methylbutanoate | 2.8 |
| (Z)-3-hexenyl acetate | 1.5 |
| (Z)-3-hexenyl butanoate | 2.4 |
| 2-hydroxy benzaldehyde | 1.5 |
| indole | 2.3 |
| iodobenzene | 3.2 |
| 3-iodotoluene | 3.7 |
| isobutyl phenylacetate | 3.2 |
| 4-isopropyl benzaldehyde | 3.0 |
| 1-isopropyl-4-methylbenzene | 4.0 |
| 5-isopropyl-2-methylphenol | 3.1 |
| 2-isopropyl phenol | 2.7 |
| limonene (1-methyl-4-(1-methylethenyl)-cyclohexene | 4.8 |
| (+)-(S)-1(6),8-p-menthadien-2-one | 1.0 |
| (1R,4R)-8-mercapto-3-p-menthanone | 2.9 |
| methyl benzoate | 1.8 |
| 3-methyl butylamine | 1.1 |
| 6-methyl quinolene | 2.6 |
| 6-methyl-5-hepten-2-one | 1.0 |
| 6-methyl-5-hepten-2-one | 1.0 |
| 2-methyl hexanoic acid | 2.1 |
| S-methyl-3-methylbutanethioate | 2.1 |
| nonanoic acid | 3.5 |
| nonane | 4.8 |
| 1-nonanol | 3.3 |
| (Z)-6-nonen-1-ol | 2.3 |
| octan-2-one | 2.3 |
| octanol | 2.8 |
| 1-octen-3-ol | 2.7 |
| octyl acetate | 3.3 |
| octyl isobutyrate | 4.2 |
| oleic acid | 7.4 |
| 1-octyl-2-pyrrolidinone | 3.3 |
| pentafluorobenzene | 3.0 |
| 2-phenyl ethyl octanoate | 4.7 |
| 2-phenylethyl 3-methyl-2-butenoate | 2.7 |
| 3-phenyl propanoic acid | 1.8 |
| 2-propenyl isothiocyanate | 1.2 |
| pyridine | 0.8 |
| tetradecane | 7.2 |
| toluene | 2.5 |
| triacetin | 0.4 |
| 1,3,5-trifluorobenzene | 2.6 |
| α,α,α-trifluorotoluene | 3.6 |
| 1,3,5-trimethyl-benzene (Mesitylene) | 3.6 |
| n-undecane | 5.7 |
| undecan-2-one | 3.7 |
| xylene | 3.1 |

The fungal cell or a fragment thereof may be derived from one or more fungi from the group comprising Mastigomycotina, Zygomycotina, Ascomycotina, Basidiomycotina and Deuteromycotina. Preferably, the fungal cell or a fragment thereof may be derived from one or more fungi from Ascomycotina. More preferably, the fungal cell or a fragment thereof may be derived from yeasts. More preferably still, the fungal cell or a fragment thereof may be derived from one or more of the group comprising Candida albicans, Blastomyces dermatitidis, Coccidioides immitis, Paracoccidioides brasiliensis, Penicillium marneffei and Saccharomyces cerevisiae. Even more preferably still, the fungal cell or a fragment thereof may be derived from Saccharomyces cerevisiae, such as common bakers yeast and yeast obtainable as a byproduct of ethanol biofuel production.

In one composition according to the present invention, the fungal cell or fragment thereof is or is derived from yeast. More preferably, the yeast is or is derived from common bakers or ethanol biofuel yeast, or other Saccharomyces yeasts. When the adjuvant comprises a fungal cell, the fungal cell may be alive or dead. The adjuvant may comprise a plurality of fungal cells or fragments thereof, and may comprise a plurality of different types of fungal cells or fragments thereof. Cells suitable for use in the present invention may be the byproduct of the yeast extract process where a degree of cell contents have been removed and the cell membrane may be intact or damaged. Preferably cells will have intact cell walls and may be described as cell walls.

The target for delivery of the compositions of the present invention may be any exterior surface of a plant. Preferably the target is a leaf surface.

Compositions according to the present invention can be converted into the customary formulations, such as solutions, emulsions, suspensions, powders, foams, pastes, granules, aerosols, active-compound-impregnated natural and synthetic materials, very fine encapsulations in polymeric substances and in coating compositions and also ULV cold mist and warm mist formulations.

These formulations are prepared in a known manner, for example by mixing the composition with extenders, that is, liquid solvents, pressurized liquefied gases and/or solid carriers, optionally with the use of surface-active agents, that is, emulsifying agents and/or dispersing agents, and/or foam-forming agents. In the case of the use of water as an extender, organic solvents can, for example, also be used as auxiliary solvents. Liquid solvents that are suitable in the main: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, also strongly polar solvents, such as dimethylformamide and dimethyl sulphoxide, as well; liquefied gaseous extenders or carriers, liquids which are gaseous at ambient temperature and under atmospheric pressure, for example aerosol propellant, such as halogenated hydrocarbons as well as butane, propane, nitrogen and carbon dioxide; as solid carriers there are suitable: for example ground natural minerals, such as kaolins, clays, talc, chalk, quartz, attapulgite, montmorillonite or diatomaceous earth, and ground synthetic minerals, such as finely divided silica, alumina and silicates; as solid carriers for granules there are suitable: for example crushed and fractionated natural rocks such as calcite, marble, pumice, sepiolite and dolomite, as well as synthetic granules of inorganic and organic meals, and granules of organic material such as sawdust, coconut shells, maize cobs and tobacco stalks; as emulsifying and/or foam-forming agents there are suitable: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as protein hydrolysates as dispersing agents there are suitable: for example lignin-sulphite waste liquors and methylcellulose.

Adhesives such as carboxy-methylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Further additives may be mineral and vegetable oils.

It is possible to use colourants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The compositions of the present invention are suitable for combating pest plants encountered in agriculture, in forestry etc.

The abovementioned pest plants include:
Field Pansy (Viola avensis), Chickweed (Stellaria media), Field Bindweed (Convulvulus avensis), Fat Hen (Chenopodium album) or volunteers from crops such as: oilseed rape, potatoes, brassicas or cereals.
Weeds in rice include:

TABLE 2

| Common Name | Scientific Name |
|---|---|
| arrowhead, California | Sagittaria montevidensis |
| arrowhead, Gregg | Sagittaria longiloba |
| barnyardgrass | Echinochloa crus-galli |
| bulrush, ricefield | Scirpus mucronatus |
| bulrush, river | Scirpus fluviatilis |
| burhead | Echinodorus cordifolius |
| cattails | Typha spp. |
| ducksalad | Heteranthera limosa |
| naiads | Najas spp. |
| pondweed, American | Potamogeton nodosus |
| redstems | Ammannia spp. |
| sedge, smallflower umbrella | Cyperus difformis |
| spikerushes | Eleocharis spp. |
| sprangletop, bearded | Leptochloa fascicularis |
| watergrasses | Echinochloa spp. |
| waterhyssops | Bacopa spp. |
| waterplantain, common | Alisma plantago-aquatica |

Weeds in wheat and barley:

TABLE 3

| Common Name | Scientific Name |
|---|---|
| barley, hare (wild) | Hordeum leporinum |
| barnyardgrass | Echinochloa crus-galli |
| bassia, fivehook | Bassia hyssopifolia |
| bindweed, field | Convolvulus arvensis |
| bluegrass, annual | Poa annua |
| brome, ripgut | Bromus diandrus |
| burclover, California | Medicago polymorpha |
| buttercup, crowfoot | Ranunculus sceleratus |
| canarygrass, hood | Phalaris paradoxa |
| canarygrass, littleseed | Phalaris minor |
| chamomile, mayweed | Anthemis cotula |
| chickweed, common | Stellaria media |
| fiddleneck, coast | Amsinckia menziesii var. intermedia |
| filarees | Erodium spp. |
| foxtails (yellow and green) | Setaria spp. |
| goatgrass, jointed | Aegilops cylindrica |
| goosefoot, nettleleaf | Chenopodium murale |
| groundsel, common | Senecio vulgaris |
| henbit | Lamium amplexicaule |
| johnsongrass | Sorghum halepense |
| knotweed, prostrate | Polygonum aviculare |
| kochia | Kochia scoparia |
| ladysthumb | Polygonum persicaria |
| lambsquarters, common | Chenopodium album |
| lettuce, prickly | Lactuca serriola |
| mallow, little (cheeseweed) | Malva parviflora |
| milkthistle | Silybum marianum |
| miner's lettuce | Claytonia perfoliata |
| mustards | Brassica spp. |
| nettle, burning | Urtica urens |
| nutsedge, yellow | Cyperus esculentus |
| oat, wild | Avena fatua |
| oxtongue, bristly | Picris echioides |
| pigweed, redroot | Amaranthus retroflexus |
| pimpernel, scarlet | Anagallis arvensis |
| pineapple-weed | Chamomilla suaveolens |
| polypogon, rabbitfoot | Polypogon monspeliensis |
| radish, wild | Raphanus raphanistrum |
| redmaids (desert rockpurslane) | Calandrinia ciliata |
| rocket, London | Sisymbrium irio |
| ryegrass, Italian | Lolium multiflorum |
| shepherd's-purse | Capsella bursa-pastoris |
| smartweed, pale | Polygonum lapathofolium |
| sowthistle, annual | Sonchus oleraceus |
| sowthistle, spiny | Sonchus asper |
| spurge, prostrate | Chamaesyce humistrata |
| spurry, corn | Spergula arvensis |
| starthistle, yellow | Centaurea solstitialis |
| stickleafs | Menizelia spp. |
| tarweed, coast | Hemizonia corymbosa |
| tarweed, hayfield | Hemizonia congesta |
| thistle, Russian | Salsola tragus |

In accordance with a second aspect of the present invention, there is provided an agrochemical composition comprising at least one lipid soluble phytoactive compound directed against a weed, and an encapsulating adjuvant, wherein the adjuvant comprises a fungal cell or fragment thereof.

The term “directed against a weed” as used herein is meant to relate to those herbicidal compounds which are intended to be used to control weeds by, for example, inhibiting one of the weeds developmental stages, damaging the integrity of the weed's cellular structures, inhibiting an essential plant biological pathway etc.

In one aspect of the present invention, the lipid soluble phytoactive compound is encapsulated by the adjuvant.

Methods of microbially encapsulating compounds are described in GB2162147, which describes special microbe cultivation methods to enhance microbial lipid content to a very high level whereby the encapsulating material is lipid soluble, and EP242135 which describes an improved method of encapsulation.

Preferably, the fungal cell is in grown form, ie. It has been harvested from its culture medium, and is intact, ie. not lysed. The fungal cell may be alive, or may be dead, ie. unable to propagate, it may be a ghost cell having much of its cellular contents extracted.

In one composition according to the present invention, the fungal cell has an average diameter of less than 6 microns. The lipid content may be less than 60%, preferably less than 40%, more preferably less than 25%, still more preferably less than 15%, most preferably less than 5% by dry weight of the cell.

In accordance with a further aspect of the present invention there is provided a method of inhibiting weed growth in a growth medium comprising the use of a composition as described herein above, the method comprising contacting the weed and/or growth medium with the composition.

Contacting the weed and/or growth medium with the composition is preferably performed by spraying. As a consequence, the composition will lie on the growth medium or on a surface of the weed such that the composition is not leeched away. Furthermore, the present invention can be used in an aquatic environment, such as a rice paddy, general amenities, pond etc. whereby the adjuvant can adhere to aquatic plant life more readily than a phytoactive compound alone. Thus there is a better chance that the phytoactive compound will not be washed away and the effect thereof will be improved. Furthermore, since the adjuvant is biodegradable and gives rise to a gradual, controlled release of the phytoactive compound, the present invention provides an environmentally benign and effective treatment.

The growth medium may comprise soil in a grow bag, a garden or a field in which plants, for example crops, are planted or are intended to be planted.

The phytoactive compound may be contacted with the plant as described hereinabove or by any other means known to the skilled person.

In accordance with a further aspect of the present invention, there is provided a method of protecting a plant using a composition as described hereinabove, wherein the method comprises contacting the plant with the composition.

In accordance with a further aspect of the present invention, there is provided the use of an encapsulating fungal cell or fragment thereof to augment the bioavailability of a phytoactive compound.

In accordance with a further aspect of the present invention, there is provided a method of killing a weed comprising exposing the weed to a composition as described hereinabove.

In accordance with a further aspect of the present invention, there is provided the use of a composition as described hereinabove for controlling weeds in crops of cultivated plants.

A composition for the selective control of weeds in crops of cultivated plants, comprising a herbicidally effective amount of a herbicidal compound encapsulated within an adjuvant, wherein the adjuvant comprises a fungal cell or fragment thereof.

Specific embodiments of the present invention will now be described, by way of example only, and with reference to the accompanying examples, in which:

### EXAMPLE 1

This example demonstrates the efficacy of Micap™ yeast based encapsulation as a method of formulation for the herbicide MCPA based on process patent EP 242 135. MCPA was supplied as a free acid, and is generally known to be somewhat phytotoxic to non target plants. This was tested as a yeast based formulation against MCPA supplied as proprietary dimethylamine salt.

### Materials and Methods

Test plants were established in 12 cm disposable pots using JI No 2 Compost, plants were sown at 4 seeds per pot.

Test species were:—

| Common | Scientific | BASF |
|---|---|---|
| Name | Name | code |
| Spring wheat | Triticum aestivum | TEZAW |
| Spring Barley | Hordium vulgare | HORVE |
| Spring oilseed rape | Brasica napus | BRSNA |
| Field Pansy | Viola avensis | VIOAR |
| Chickweed | Stellaria media | STEME |
| Field Bindweed | Convulvulus avensis | CONAR |
| Fat Hen | Chenopodium album | CHEAL |
| Summer Cauliflower | Brassica oleracae | |

Once germinated all plants were grown outside to allow natural leaf surface development. Test plants were selected for uniformity of both plant size and plant number per pot.

Plant growth stage at application. Wheat and Barley 30, Rape 1, 6, Other weeds 4 to 5 leaves, summer cauliflower 7 leaves.

### Test Products

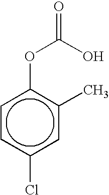

### MCPA

### Common Name

(4-chloro-2-methylphenoxy)acetic acid (MCPA) [CSA#94-74-6].

MCPA was supplied as a yeast based formulation of technical grade free acid by Micap plc batch number 3067.

It is proposed efficacy will be proven for the encapsulated MCPA esters for example; MCPA-butoxyethyl [19480-43-4], MCPA-butyl [1713-12-8], MCPA-2-ethylhexyl [29450-45-1], MCPA-isobutyl [1713-11-7], MCPA-iso-octyl [26544-20-7], MCPA-isopropyl [2698-40-0], MCPA-methyl [2436-73-9], MCPA-thioethyl [25319-90-8].

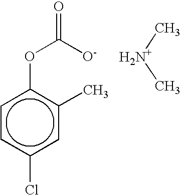

### MCPA (DMA)

### Common Name

(4-chloro-2-methylphenoxy)acetic acid dimethylamine salt [2039-46-5].

MCPA (DMA) was supplied as a commercial formulation by A. H. Marks as a 500 g AI/litre formulation, batch number Jet/03/11.

Rate of application. The recommended application rate for field use is between 1.4 litres per Hectare and 3.5 litres per Hectare of 50% a.i. of MCPA formulated as a dimethylamine salt depending on the state of the crop and target species. (BASF 2003), Both the above formulations were applied as a series dilution of 5.0, 2.5, 1.25, 0.625 and 0.3125 litres per Hectare. A water only treatment was applied as an untreated control, making a total of 11 treatments. The treatments were replicated four times for all species, apart from Summer Cauliflower, which was replicated twice.

The test products were applied to plants using a dedicated experimental pot sprayer.

Plants to be sprayed were placed in a single row on the spray bench such that when operated the plants were equidistant between two 015 F110 nozzles. The spray nozzles were run 50 cm above the target plants.

Test products were applied sequentially starting with water and ending with the 5.0 encapsulated product. Following spraying, all plants were moved to a side-ventilated polythene tunnel where pots were laid out on a single bench in four randomised blocks.

Plants were subsequently watered from below as required and assessed for phyto-toxicity 2, 6, 12 and 37 days post application.

### Results.

Data as collected on days 2, 6, 12 and 37 was subject to testing for analysis of variance using Agrobase a Foxpro based statistical package.

No significant phyto-toxicity effects were observed on either wheat or barley on any of the observation dates. No significant phtyo-toxic effects were observed two or six days post application, there were significant treatment effects on days 12 and 37.

### Summary by Species

### Wheat and Barley.

No adverse effects were observed on either crop.

### Rape.

No significant phytotoxic effects were observed on day 37. For the conventional formulation there was a significant dose related effect on plants.

### Fathen.

There were significant differences between water only and higher application levels of AI. By day 12 there were significant interactions between AI level and formulation but what these were is unclear, by day 37 the only significant effect was product rate.

### Pansy

Significant differences were observed between treatments. By day 37 the lower application rates of MCPA actually produced more vigorous plants than untreated only plants.

### Knotgrass.

Significant differences were observed between treatments and encapsulated MCPA was significantly more effective that the conventional formulation.

### Speedwell

Significant differences were observed between treatments. Encapsulated MCPA was more effective that the conventional formulation. At normal field rate and half field rate, the enhancement due to encapsulation was pronounced.

### Cauliflower

Significant differences were observed between treatments including water on days 12 and 37. By day 37 AI level formulation alone was significant.

No phytotoxicity was observed on the non-target species Wheat and Barley.

MCPA when applied as an encapsulated product was at least as effective as a conventional MCPA formulation on the six species assessed in this trial. Encapsulated MCPA showed enhanced efficacy against two species, Knotgrass and Speedwell.

### Selective Herbicides

Combining the yeast encapsulation technology with careful selection of herbicides and other phytoactive compounds either used singly or in combination may lead to more effective crop management strategies.

### Broadleaved Weeds

### 2,4-D

Mecoprop-P & mecoprop

### Ioxynil

### Bromoxynil

### Diacamba

### MCPA

### Simazine/atrazine

### Grasses

Tralkoxydim & Clethodim (DIMS herbicides)
Fenoxaprop & Fluazifop-p (FOPS herbicides)

### Propargyl

### Non-Selective Herbicides

### Diquat

### Paraquat

### Glyphosate

Many are water soluble and thus not suitable for encapsulation in microorganisms using the methods currently employed.

### Herbicide Encapsulation in Microorganisms

Examples of encapsulation process conditions are described hereinbelow to demonstrate the microbial encapsulation of herbicides, plant growth regulators, safeners and related compounds in yeast.

### Equipment & Materials

Thermostatically controlled water bath
Reaction flask
Overhead stirrer motor
Paddle stirrer
Top pan Balance
Bench Top Centrifuge
Buchi mini spray drier (B-290)

### EXAMPLE 2

### Encapsulation of an Acidic Herbicide

### Mixing

The water bath was heated to 40° C.
The solid active ingredient (a.i.) weighed out i.e. (125 g MCPA free acid, technical grade) and was made up into a known volume (450 ml) of appropriate solvent (benzyl alcohol).
Following the recipe 1 part a.i./carrier to 2 parts yeast to at least 4 parts water, by weight (e.g. 250 g/500 g/1000 g) 1800 g water was measured into a reaction flask and heated to the required temperature (40° C.), mixing with a paddle stirrer at approximately 150 rpm.
900 g instant dried active bakers yeast (Saccharomyces cerevisiae) was added to the water to create slurry, conditioned for 20 minutes stirring continuously.
The volume was adjust by addition of water when the mixture became highly viscous, typical for example for active yeast and particularly hygroscopic yeast.
450 g of the a.i./solvent was added and mixed for 17.5 hours.

### Separation

The encapsulation mixture was poured into centrifuge pots (750 ml tubes) until one third full.
The equivalent volume of water was add and the pots balanced to within ⁺/₋1% by weight. The mixture was centrifuged at 3200 rpm for 20 minutes at (4° C.) 4° C. above carrier/solvent melting point.
The supernatant/waste was decanted from the pots into a waste drum.

The recovery of active ingredient from the waste stream is desirable and can be readily achieved by one skilled in the art.

Post Encapsulation Washing with Water
The pellet was resuspended in an excess volume of water and centrifuge for at 3200 rpm for 20 minutes at 4° C. (4° C. above carrier/solvent melting point).
The supernatant was decanted from the pots and water was added as required to resuspend the pellet.

The encapsulated product is ready for use at this stage but typically the product is dried by spray drying.
The product was resuspended to less than 20% solids by weight prior to spray drying.

### Spray Drying

The diluted wet pellet was transferred to a plastic beaker (e.g. 1-2 litre capacity) to produce a feedstock consisting of approximately 20% solids by weight.
The mixture was stirred continuously and fed into the drier via a peristaltic pump.
Buchi mini spray drier was set and operated according to the manufacturer's instructions. The pump speed was adjusted to maintain an inlet temperature between 110-130° C. and an outlet temperature between 80-95° C.

The encapsulation level of MCPA was 90 mg/g dry wt. The encapsulation level of benzyl alcohol was 45 mg/g dry wt. The moisture content of the final product was 2.4%.

### EXAMPLE 3

### Encapsulation of an Acidic Herbicide with pH Adjustment to Increase Loading

### Mixing

The water bath was heated to 40° C.
The solid active ingredient (a.i.) weighed out i.e. (125 g MCPA free acid, technical grade) and was made up into a known volume (450 ml) of appropriate solvent (benzyl alcohol).
Following the recipe 1 part a.i./carrier to 2 parts yeast to at least 4 parts water, by weight (e.g. 250 g/500 g/1000 g) 1800 g water was measured into a reaction flask and heated to the required temperature (40° C.), mixing with a paddle stirrer at approximately 150 rpm.
900 g active bakers yeast (Saccharomyces cerevisiae) was added to the water to create slurry, conditioned for 20 minutes stirring continuously.
The volume was adjust by addition of water acidified to pH 2.0 when the mixture became highly viscous.
The pH of the slurry was adjusted to pH 2.0 with the addition of dilute hydrochloric acid.
450 g of the a.i./solvent was added and mixed for 16 hours.
The pH was maintained at pH 2.0 throughout.

### Separation

The encapsulation mixture was poured into centrifuge pots (750 ml tubes) until one third full.
The equivalent volume of acidified water (dilute acetic acid pH 2.0) was added and the pots balanced to within ⁺/₋1% by weight.
The mixture was centrifuged at 3200 rpm for 20 minutes at 4° C. above carrier/solvent melting point.
The supernatant/waste was decanted from the pots into a waste drum.
   Post Encapsulation Washing with Water
The pellet was resuspended in an excess volume of acidified water (dilute acetic acid pH 2.0) and centrifuged at 3200 rpm for 20 minutes at 4° C. (4° C. above carrier/solvent melting point).
The supernatant was decanted from the pots and acedified water was added as required to resuspend the pellet.

The encapsulated product is ready for use at this stage but typically the product is dried by spray drying.
The product was resuspended to less than 20% solids by weight prior to spray drying.

### Spray Drying

The diluted wet pellet was transferred to a plastic beaker (e.g. 1-2 litre capacity) to produce a feedstock consisting of approximately 20% solids by weight.
The mixture was stirred continuously and fed into the drier via a peristaltic pump.
Buchi mini spray drier was set and operated according to the manufacturer's instructions. The pump speed was adjusted to maintain an inlet temperature between 110-130° C. and an outlet temperature between 80-95° C.

The encapsulation level of MCPA was 143 mg/g dry wt.

The moisture content of the final product was 4.6%.

### EXAMPLE 4

### Encapsulation of an Acidic Herbicide Ester without Carrier

### Mixing

The water bath was heated to 40° C.
The liquid active ingredient (a.i.) was weighed out i.e. (125 g MCPA-2-ethylhexyl ester [cas#29450-45-1], technical grade).
Following the recipe 1 part a.i./carrier to 2 parts yeast to at least 4 parts water, by weight (e.g. 125 g/250 g/500 g) 500 g water was measured into a reaction flask and heated to the required temperature (40° C.), mixing with a paddle stirrer at approximately 150 rpm.
250 g of dead yeast (Saccharomyces cerevisiae), a byproduct from ethanol biofuel production, was added to the water to create slurry, conditioned for 20 minutes stirring continuously.
The volume was adjust slightly by addition of water as the mixture became viscous.
125 g of the a.i. was added and mixed for 18 hours.

### Separation

The encapsulation mixture was poured into centrifuge pots (750 ml tubes) until one third full.
The equivalent volume of water was added and the pots balanced to within ⁺/₋1% by weight.
The mixture was centrifuged at 3200 rpm for 20 minutes at 4° C. above carrier/solvent melting point.
The supernatant/waste was decanted from the pots into a waste drum.
   Post Encapsulation Washing with Water
The pellet was resuspended in an excess volume of water and centrifuged at 3200 rpm for 20 minutes at 4° C.
The supernatant was decanted from the pots and water was added as required to resuspend the pellet.

The encapsulated product is ready for use at this stage but typically the product is dried by spray drying.
The product was resuspended to less than 20% solids by weight prior to spray drying.

### Spray Drying

The diluted wet pellet was transferred to a plastic beaker (e.g. 1-2 litre capacity) to produce a feedstock consisting of approximately 20% solids by weight.
The mixture was stirred continuously and fed into the drier via a peristaltic pump.
Buchi mini spray drier was set and operated according to the manufacturer's instructions. The pump speed was adjusted to maintain an inlet temperature between 110-130° C. and an outlet temperature between 80-95° C.
The encapsulation level of MCPA ester was 5.8% dry wt.

### EXAMPLE 5

### Encapsulation of an Acidic Herbicide Ester with Carrier

### Mixing

The water bath was heated to 40° C.
The solid active ingredient (a.i.) weighed out i.e. (125 g MCPA-2-ethylhexyl ester [cas#29450-45-1], technical grade) and was made up into a known volume (250 ml) of appropriate solvent (benzyl alcohol).
Following the recipe 1 part a.i./carrier to 2 parts yeast to at least 4 parts water, by weight (e.g. 250 g/500 g/1000 g) 1000 g water was measured into a reaction flask and heated to the required temperature (40° C.), mixing with a paddle stirrer at approximately 150 rpm.
500 g instant dried active bakers yeast (Saccharomyces cerevisiae) was added to the water to create slurry, conditioned for 20 minutes stirring continuously.
The volume was adjust by addition of water when the mixture became highly viscous, typical for example for active yeast and particularly hygroscopic yeast.
250 g of the a.i./solvent was added and mixed for 5 hours.

### Separation

The encapsulation mixture was poured into centrifuge pots (750 ml tubes) until one third full.
The equivalent volume of water was add and the pots balanced to within ⁺/₋1% by weight.
The mixture was centrifuged at 3200 rpm for 20 minutes at (4° C.) 4° C. above carrier/solvent melting point.
The supernatant/waste was decanted from the pots into a waste drum.

The recovery of active ingredient from the waste stream is desirable and can be readily achieved by one skilled in the art.

Post Encapsulation Washing with Water
The pellet was resuspended in an excess volume of water and centrifuge for at 3200 rpm for 20 minutes at 4° C. (4° C. above carrier/solvent melting point).
The supernatant was decanted from the pots and water was added as required to resuspend the pellet.

The encapsulated product is ready for use at this stage but typically the product is dried by spray drying.
The product was resuspended to less than 20% solids by weight prior to spray drying.

### Spray Drying

The diluted wet pellet was transferred to a plastic beaker (e.g. 1-2 litre capacity) to produce a feedstock consisting of approximately 20% solids by weight.
The mixture was stirred continuously and fed into the drier via a peristaltic pump.
Buchi mini spray drier was set and operated according to the manufacturer's instructions. The pump speed was adjusted to maintain an inlet temperature between 110-130° C. and an outlet temperature between 80-95° C.

The encapsulation level of MCPA ester was 5.8% by dry wt.

TABLE 4
Herbicides listed by log P

| | | M. Pt. | | | |
|---|---|---|---|---|---|
| Name of pesticide: | Log P | (deg C.) | Mol. Wt | Manufacturer | Chemical Class |
| paraquat* (i) | 7.00 | ? | 186.0 | syngenta | quaternary ammonium herbicides |
| pendimethalin | 5.18 | 56 | 281.3 | basf | dinitroaniline herbicides |
| trifluralin | 4.83 | 48.7 | 335.3 | various | dinitroanline herbicides |
| acetochlor | 4.14 | 10.6 | 269.8 | Dow, Monsanto | chlorocetanilide herbicides |
| oxaziclomefone# | 4.01 | 150 | 376.3 | aventis | unclassified herbicides |
| glufosinate* (ii) | 3.90 | ? | 121.0 | aventis | organophosphorous herbicides |
| fenoxaprop (iii) | 3.83 | ? | 141.5 | aventis | aryloxyphenoxypropionic herbicides |
| Fentrazamide# | 3.60 | 79 | 349.8 | bayer | amide herbicides |
| butafenacil*# | 3.20 | 113 | 474.8 | syngenta | uracil herbicides |
| Metolachlor | 3.00 | ? | 283.5 | syngenta | chloroacetanilide herbicides |
| Isoxachlortole# | 2.76 (pH 2) | ? | 325.5 | Aventis | cyclopropylisoxazole herbicides |
| tepraloxydim# | 2.76? | 74 | 341.8 | basf | cyclohexene oxime herbicides |
| 2,4-D (0.2 pH 5) | 2.6 (pH 1) | 140.5 | 221.0 | various | aryloxyalkanoic |
| atrazine | 2.50 | 175.8 | 215.7 | various | chlorotriazine herbicides |
| Mesotrione# | 2.2 | 165 | 339.3 | syngenta | benzoylcyclohexadenione herbicides |
| imazethapyr | 1.49 (pH 7) | 170 | 289.3 | basf | imidazolinone herbicides |
| amicarbazone# | 1.23 (pH 7) | 160 | 369.4 | bayer | triazolone herbicides |
| bentazone | 0.77 | 140 | 240.3 | basf | unclassified herbicides |
| mesosulfuron# | ? | ? | 297.0 | aventis | pyrimidinylsulfonylurea herbicides |
| foramsulfuron# | ? | ? | 248.0 | aventis | pyrimidinylsulfonylurea herbicides |
| pyriftalid# | ? | ? | 138.0 | syngenta | unclassified herbicides |
| bilanafos* | −6.37 | ? | 323.3 | meiji seika | antibiotic herbicides |
| clopyralid | −1.81 | 151 | 192.0 | dow | picolinic acid herbicides |
| diquat* (iv) | −3.05 | ? | 40.0 | syngenta | quaternary ammonium herbicides |
| glyphosate* | −3.30 | 189.5 | 169.1 | Monsanto | organophosphorous herbicides |

*= non-selective herbicides
#= newly-introduced
(i) - paraquat often present as paraquat dichloride (water soluble)
(ii) - glufosinate oten present as glufosinate ammonium
(iii) - fenoxaprop often present as fenoxaprop-p-ethyl
(iv) - diquat often present as diquat dibromide

TABLE 5

| | | | Solid/ | |
|---|---|---|---|---|
| Active | Manufacturer | Trade Name | liquid | Log Pow |
| acifluorfen | BayerCropscience (ex Aventis) | Blazer, Status, Tackle, MC-10978 | s | 4.2 |
| aclonifen | BASF (ex Am.Cy.) | Bandur, Bandren, CME 127, KUB 3359 | s | 4.7 |
| ametryn | Syngenta (ex Nov.) | Gesapax, Evik, G-34162 | s | 2.6 |
| amicarbazone | BayerCropScience | BAY MKH 3586 | s | 1.2 |
| amidosulfuron | BayerCropscience (ex Aventis) | Adret, Gratil, HOE-75032 | s | 1.6 |
| azafenidin | DuPont | Evolus, Milestone, DPX-R6447 | s | 2.7 |
| beflubutamid | Ube Industries Ltd | benfluamid, UBH-820 | s | 4.3 |
| benzobicyclon | | | s | 3.1 |
| benzofenap | Mitsubishi Chemical | Yukawide, MY-98 | s | 4.7 |
| bifenox | BayerCropscience (ex Aventis) | Modown, MC-4379 | s | 4.5 |
| bromacil | DuPont | Hyvar X, DuPont 976 | s | 1.9 |
| bromoxynil | BayerCropscience (ex Aventis) | Brominal, Buctril, MB10064 | s | 2.8 |
| butafenacil | Syngenta (ex Nov.) | Inspire, CGA-276854 | s | 3.2 |
| butralin | CFPI Nufarm | | s | 3.9 |
| butroxydim | Syngenta (ex Zen.) | Falcon, ICI-A0500 | s | 1.9 |
| cafenstrole | Eikou Kasel | | s | 3.2 |
| carfentrazone-ethyl | FMC | Aim, Affinity, F 8426 | l | 3.4 |
| chloramben | Aventis | | s | 1.9 |
| chlorbromuron | Syngenta (ex Nov.) | Maloran, C-6313 | s | 2.9 |
| chlorotoluron | Syngenta (ex Nov.) | Dicuran, C-2242 | s | 2.5 |
| chlorthal-dimethyl | ISK Biosciencees group | | s | 4.3 |
| cinidon-ethyl | BASF | | s | 4.5 |
| clethodim | Valent | Select, Prsim, RE-45601 | l | 4.2 |
| clodinafop-propargyl | Novartis | | s | 3.9 |
| clomazone | FMC | Command, F-57020 | l | 2.5 |
| cloquintocet-mexyl | | | s | 5 |
| cloransulam-methyl | Dow AgroSciences | First Rate, XDE-565 | s | 1.2 |
| cyanazine | BASF (ex Am.Cy.), Griffin | Bladex, WL 19805 | s | 2.1 |
| cycloate | syngenta | | l | 3.9 |
| cycloxydim | BASF | Focus, Laser, Stratos, BAS 517 | s | 1.4 |
| desmedipham | BayerCropscience (ex Aventis) | Betanal AM, Betanex, SN 38107 | s | 3.4 |
| diclofop-methyl | BayerCropscience (ex Aventis) | Hoegrass, Hoelon, Ilioxan, HOE 23408 | mp 40 | 4.6 |
| diflufenican | BayerCropscience (ex Aventis) | Cougar, Javelin, MB-38183 | s | 4.9 |
| dimefuron | Aventis | | s | 2.5 |
| dimethametryne | Syngenta (ex Nov.) | Avirosan, C-18898 | s | 3.8 |
| dimethenamid | BASF | | s | 2.1 |
| dinitramine | Wacker GmbH | | s | 4.3 |
| dinoterb | Aventis | | s | 3.6 |
| dinoterb acetate | Aventis | | s | 3.1 |
| ethafluralin | Dintec | | s | 5.1 |
| ethofumesate | Aventis | | s | 2.7 |
| fenoxaprop-p-ethyl | BayerCropscience (ex Aventis) | Super Whip, Option Super, Exel Super, HOE-46360, | s | 4.6 |
| | | Aclaim, Puma S | | |
| fenuron | DuPont, Hopkins | PDU | s | 1.4 |
| flamprop-M | BASF | | s | 3.1 |
| flamprop-M-methyl | BASF | | s | 3 |
| flamprop-M-isopropyl | BASF | | s | 3.7 |
| fluazifop | Ishirhara Sangyo | | s | 3.2 |
| fluazifop-P | Syngenta | | s | 3.1 |
| fluazifop-butyl | Ishirhara Sangyo | | s | 4.5 |
| fluazifop-p-butyl | Syngenta (ex Zen.) | Fusilade, Fusilade 2000, Fusilade DX, ICI-A 0009, ICI-A | l | 4.5 |
| | | 0005, SL-236, IH-773B, TF-1169 | | |
| fluazolate | BayerCropScience, Monsanto | Twin-Agro | s | 5.4 |
| fluchloralin | BASF | | s | 5.1 |
| flufenacet | BayerCropScience | | s | 3.2 |
| flumiclorac-pentyl | Sumitomo, Valent | Resource, Sumivere, S-2303, V-23031 | s | 5 |
| flumioxazin | Sumitomo | Sumisoya, S-53482, V53482 | s | 1.3 |
| fluoroglycofen-ethyl | Rohm & Haas | Compete, Satis, Simtar, RH-0265 | s | 3.7 |
| flurenol | BASF | | s | 1.3 (pH) |
| flurenol-butyl | BASF | | s | 3.7 |
| flurochloridone | Syngenta (ex Zen.) | Racer, R-40244 | s | 3.4 |
| fluroxypyr | Dow AgroSciences | | s | 1.2 |
| fluroxypyr-meptyl | Dow AgroSciences | | s | 4.5 |
| fluroxypyr-2-butoxy-1- | Dow AgroSciences | | l | 4.2 |
| methylethyl | | | | |
| flurtamone | BayerCropscience (ex Aventis) | Bacara, Ro-40885 | s | 2.9 |
| fluthiacet-methyl | Syngenta (ex Nov.) | Action, KiH-9201 | s | 3.8 |
| fomesafen | Syngenta (ex Zen.) | Reflex, Flexstar, Flex, PP-021 | s | 2.9 (pH 1) |
| haloxyfop-etotyl | Dow AgroSciences | Gallant, DOWCO 453EE | s | 4.3 |
| haloxyfop-methyl | Dow AgroSciences | Verdict, DOWCO 453ME | s | 3.7 |
| haloxyfop-P-methyl | Dow AgroSciences | Edge, DE 535 | l | 4 |
| haloxyfop-P | Dow AgroSciences | | s | |
| haloxyfop | Dow AgroSciences | | s | 3.4 |
| hexazinone | DuPont | Velpar, DPX-3674 | s | 1.2 |
| imazamethabenz | BASF (ex Am.Cy.) | | s | 3.3 |
| imazamethabenz-methyl | BASF (ex Am.Cy.) | Assert, AC 22293 | s | 1.54 |
| imazaquin | BASF (ex Am.Cy.) | Scepter, Image, AC 252214 | s | 2.9 |
| imazethapyr | BASF (ex Am.Cy.) | Pursuit, Pivot, AC 263499 | s | 1 |
| indanofan | Mitsubishi Chemical | | s | 3.6 |
| ioxynil, | BayerCropscience (ex Aventis) | Actril, Certrol, Bantrol, ACP 63-303, MB 8873 | s | 3.4 |
| ioxynil octanoate | Various | | s | 6.4 |
| isouron | Shionogi | | s | 2 |
| isoxaben | Dow AgroSciences | | s | 3.9 |
| isoxaflutole | BayerCropscience (ex Aventis) | Balance, Merlin, RP-201772, EXP-30953 | s | 2.3 |
| lactofen | Valent | Cobra, PPG 844 | s | 4.9 |
| linuron | Various | | s | 3 |
| MCPA-butoxyethyl | | | s | 4 |
| MCPA-2-ethylhexyl | Nufarm | | s | 6.2 |
| MCPA | Various | | s | 2.8 (pH 1) |
| MCPA-thioethyl | Hokko | | s | 4.1 |
| MCPB | Aventis | | s | 2.4 |
| mecoprop (MCPP), | Nufarm | | s | 0.1-3.2 (pH) |
| mecoprop-p | | | | |
| mefenacet | Bayer | | s | 3.2 |
| mefenpyr-diethyl | Aventis | | s | 3.8 |
| mefluidide | PBI/Gordon | | s | 2 |
| metamitron | BayerCropScience | Goltix, BAY DRW 1139 | s | 0.8 |
| metazachlor | BASF | | s | 2.1 |
| methabenzthiazuron | Bayer | | s | 2.6 |
| methyldymron | SDS Biotech KK | | s | 3 |
| metobenzuron | Mitsui | | s | 6.3 |
| metobromuron | Novartis | | s | 2.4 |
| metolachlor | Novartis | | l | 2.9 |
| S-metolachlor | Novartis | | l | 3.1 |
| metosulam | Dow AgroSciences | Pronto, Eclipse, Uptake, DE 511 | s | 3.1 (pH 9) |
| metoxuron | Atul | | s | 1.6 |
| metribuzin | BayerCropScience, DuPont | Sencor, Sencorex, BAY 94337, Lexone, DPX-2504 | s | 1.6 |
| MK-616 | Mitsubishi Chemical | | s | 2.9 |
| molinate | Various | | l | 2.9 |
| monolinuron | Aventis | | s | 2.2 |
| naproanalide | Mitsui | | s | 4.4 |
| napropamide | UP | | s | 3.3 |
| norflurazon | Syngenta (ex Nov.) | Zorial, Solicam, SAN-978938 | s | 2.5 |
| orbencarb | Ihara/Kumiai | | l | 3.4 |
| Oryzalin | Dow AgroSciences | | s | 3.7 |
| oxadiargyl | BayerCropscience (ex Aventis) | RP-020630, SAN-1315, Raft, Topstar | s | 4 |
| oxadiazon | BayerCropscience (ex Aventis) | Ronstar, Foresite, RP-17623 | s | 4.9 |
| oxaziclomefone | Aventis | | s | 4 |
| oxyfluorfen | Makhteshim-Agan, Rohm & Haas | Goal, Koitar, RH-2915 | s | 4.5 |
| Pebulate | Syngenta | | l | 3.8 |
| Pendimethalin | BASF | | s | 5.2 |
| pentanochlor | FMC | | s | 4.2 |
| phenmedipham | Aventis | Betanal, SN 38584 | s | 3.6 (pH 3.9) |
| picolinafen | BASF (ex Am.Cy.) | AC-900,001 | s | 5.4 |
| piperophos | Novartis | | l | 4.3 |
| pretilachlor | Novartis | | l | 4.1 |
| primisulfuron-methyl | Syngenta (ex Nov.) | Beacon, Tell, CGA 136872 | s | 0.2 (pH 7) |
| prodiamine | Novartis | | s | 4.1 |
| prometon | Syngenta (ex Nov.) | Pramitol, Gesagram, G-31435 | s | 3.6 |
| prometryn | Syngenta (ex Nov.) | Caparol, Gesagard, G-34161 | s | 3.1 |
| propachlor | Makhteshim-Agan | | s | 1.4-2.4 |
| propanil | Rohm & Haas | Stam, Stam F-34, FW-734 | s | 3.3 |
| propaquizafop | Syngenta (ex Nov.) | Agil, Shogun, Ro 17-3664 | s | 4.8 |
| propham | Syngenta | | s | 2.7 |
| propisochlor | Nitrokemia | | s | 3.5 |
| propyzamide | Rohm & Haas | | s | 3.2 |
| prosulfocarb | Syngenta | | l | 4.7 |
| pyraflufen-ethyl | Nichino | ET-751 | s | 3.5 |
| pyrazosulfuron-ethyl | Nissan Chemical | Sirius, Agreen, NC-311 | s | 1.3 |
| pyrazoxyfen | Syngenta (ex Zen.) | Paicer, SL-49 | s | 3.7 |
| pyribenzoxim | LG Chemical | Pyanchor, Kiljabi Gold, LGC-40863 | s | 3 |
| pyributicarb | Dainippon (herbicide/fungicide) | | s | 5.3 |
| pyridate | Agrolinz/Novartis | Lentagran, Tough, CL-11344 | s | 4 |
| pyriminobac-methyl | Kumiai | Prosper, KIH-6127 | s | 3 |
| quizalofop, quizalofop- | DuPont, IPESA | Assure, Assure II, DPX-Y6202-3, Targa Super, NC-302 | l/s | 4.3-4.7 |
| p, quizalofop-p-ethyl, | | | | |
| quizalofop-P-tefuryl, | | | | |
| siduron | Raschig | | s | 3.8 |
| sethoxydim | BASF | Poast, Poast Plus, NABU, Fervinal, NP-55, Sertin | l | 4.5 |
| simazine | Syngenta (ex Nov.) | Gesatop, Princep, G-27692 | s | 2.1 |
| simetryne | Syngenta (ex Nov.) | Gybon, G-32911 | s | 2.6 |
| sulfentrazone | FMC | Authority, Boral, Capaz, F-6285 | s | 1.5 |
| sulfometuron-methyl | Takeda | | s | 1.2 (pH 5) |
| 2,3,6-TBA | | | s | 2.7 (pH) |
| (Trichlorobenzoic acid) | | | | |
| tebutam | Novartis | | l | 3 |
| tabuthiuron | Dow | | s | 1.8 |
| tepraloxydim | BASF | | s | 3.25 |
| terbacil | DuPont | Sinbar, DuPont 732 | s | 1.9 |
| terbumeton | Syngenta (ex Nov.) | Caragard | s | 3 |
| terbuthylazine | Syngenta (ex Nov.) | Gardoprim, GS-13529 | s | 3.2 |
| terbutryne | Syngenta (ex Nov.) | Igran, Prebane | s | 3.7 |
| thenylchlor | Tokuyama | | s | 3.5 |
| thiazopyr | Rohm & Haas | | s | 3.9 |
| thiobencarb | Ihara/Kumiai | | l | 3.4 |
| TI-35 (safener) | North Hungarian | | l | ? |
| tiocarbazil | Isagro | | l | 5.4 |
| tralkoxydim | Syngenta (ex Zen.) | Achieve, Grasp, Splendor, ICI-A0604 | s | 2.1 |
| tri-allate | Monsanto | | s | 4.6 |
| triclopyr | Dow AgroSciences & various | | s | 0.4 (pH 5) |
| trietazine | BayerCropscience (ex Aventis) | Remtal, NC 1667 | s | 3.44 |
| trifluralin | Various | | s | 4.8 |
| vernolate | Syngenta? | | l | 3.8 |

TABLE 6

| Herbicide | Crop plants | Weed plants | logP | Acid | Class | Notes |
|---|---|---|---|---|---|---|
| 2,4-D | Grass seed, pasture, wheat | Control of broadleaf weeds | 0-2.5 | y | Phenoxy acid | Generic. Alkyl |
| | | | | | | esters available |
| Alachlor | Maize, cotton, oilseed rape. | Grass & broadleaf weed control | 3.1 | n | Acetamide | generic |
| Bensulide | Onion | Pre-emergence grass and | 4.2 | n | Dithioate | generic |
| | | broadleaf weed control | | | | |
| Bromoxynil | Grass seed, mint, oat, onion, triticale, | Used to control difficult | 2.8 | n | Benzonitrile | generic |
| | wheat | broadleaf weeds, such as | | | | |
| | | common groundsel | | | | |
| Dichlobenil | Various | Broadspectrum | 2.7 | n | Benzonitrile | generic |
| MCPA | Cereals | | 0-2.5 | y | Phenoxy acid | Generic. Alkyl |
| | | | | | | esters available |
| Norflurazon | Alfalfa, hops | Pre-emergence control of | 2.45 | n | Pyridazinone | generic |
| | | broadleaf and grass weeds | | | | |
| Oryzalin | Various | Broadspectrum | 3.7 | n | dinitroaniline | generic |
| Oxyfluorfen | Grass seed, mint, onion | Controls numerous grass and | 4.5 | n | diphenylether | generic |
| | | broadleaf weeds in fall applications | | | | |
| Pebulate | | | 3.8 | n | Thiocarbamate | generic |
| Pendimethalin | Carrot seed, clover seed, garlic, grass | Provides pre-emergence control | 5.2 | n | Dinitroaniline | generic |
| | seed, mint, onion | of several grass and | | | | |
| | | broadleaf weeds. | | | | |
| Other classes | Pyrimidindione | Oxime | | | | |
| | Urea | Triketone | | | | |
| | Carbamate | | | | | |
| | Triazine | | | | | |
| Growth Regulators | Application | crop | | | | |
| 1-naphthylacetic acid | Root promoter in cuttings, prevents | woody plants, apples, pears, citrus. | 2.6 | y | synthetic auxin | Aventis |
| 2-naphthyloxyacetic acid | premature flower and fruit drop | tomatoes, strawberries | 2.5 | y | synthetic auxin | Cyclo |
| | fruit setting | | | | | |
| ethyl 1-naphthylacetate | Root promoter in cuttings, prevents | woody plants, apples, pears, citrus. | 3.8 | n | synthetic auxin | Aventis |
| 2-(1-naphthyl)acetamide | premature flower and fruit drop | apples, pears | | | | |
| | shoot thining | | | | | |

Safeners

| | | | | | |
|---|---|---|---|---|---|
| furilazole | protects maize and grasses | against sulfonylureas and | 2.2 | n | Monsanto |
| flurazole | seed protectant in sorgum | imidazolinones against alachlor | 4.1 | n | Monsanto |
| | | and metolachlor | | | |

1. A composition comprising at least one phytoactive compound and an encapsulating adjuvant, wherein the adjuvant comprises a fungal cell or fragment thereof.

2. A composition as claimed in claim 1 wherein the phytoactive compound comprises an herbicide, safener and/or growth regulator.

3. A composition as claimed in claim 1 wherein the fragment of fungal cell comprises a fungal cell wall or a part thereof.

4. A composition as claimed in claim 1 wherein the phytoactive compound is lipophilic or comprises a lipophilic moiety.

5. A composition as claimed in claim 4 wherein the phytoactive compound is substantially lipophilic.

6. A composition as claimed in claim 4 wherein the phytoactive compound is derived from a lipophobic compound and chemically modified to be substantially lipophilic.

7. A composition as claimed in claim 1 further comprising a colourant.

8. A composition as claimed in claim 2 wherein the herbicide comprises one or more compounds selected from the group consisting of:
esters or sulfonylureas: MCPA ((4-chloro-2-methylphenoxy)acetic acid), esters of MCPA:
MCPA (DMA) ((4-chloro-2-methylphenoxy)acetic acid dimethylamine salt [2039-46-5]; and the compounds listed in Table 4, 5 or 6.

9. A composition as claimed in claim 2 wherein the regulator comprises one or more compounds selected from the group consisting of 1-naphthylacetic acid, 2-naphthyloxyacetic acid, ethyl 1-naphthylacetate and 2-(1-naphthyl)acetamide.

10. A composition as claimed in claim 2 wherein the safener comprises one or more compounds selected from the group consisting of furilazole and flurazole.

11. A composition as claimed in claim 1 wherein the phytoactive compound has a positive partition coefficient (LogP_{o/w}).

12. A composition as claimed in claim 11 wherein the phytoactive compound has a positive partition coefficient (LogP_{o/w}) greater than 0:1.

13. A composition as claimed in claim 12 wherein the phytoactive compound has a positive partition coefficient (LogP_{o/w}) in the range 0.1-10

14. A composition as claimed in claim 13 wherein the phytoactive compound has a positive partition coefficient (LogP_{o/w}) in the range 0.5-10

15. A composition as claimed in claim 14 wherein the phytoactive compound has a positive partition coefficient (LogP_{o/w}) in the range 2.0-7.0.

16. A composition as claimed in claim 1 wherein the phytoactive compound has a pH in the range of pH 1.0-12.0.

17. (canceled)

18. A composition as claimed in claim 16 wherein the phytoactive compound has a pH in the range of pH4-9.

19. A composition as claimed in claim 1 wherein the phytoactive compound is an acid and has a pKa between 2.0-7.0.

20. A composition as claimed in claim 1 wherein the phytoactive compound is basic and has a pKa between 7.0-12.

21. A composition as claimed in claim 1 wherein the phytoactive compound is present in an amount from 1-50 g/100 g of composition.

22. A composition as claimed in claim 1, wherein the phytoactive compound is a liquid at s.t.p or is dissolvable in an organic solvent.

23. A composition as claimed in claim 22 wherein the phytoactive agent is soluble in an organic solvent at a level above 10 g/l.

24. A composition as claimed in claim 1 that further comprises a carrier that facilitates encapsulation of the phytoactive compound within the adjuvant.

25. A composition as claimed in claim 24 wherein the carrier is selected from one or more of the group consisting of alkanes, alkenes, alkynes, aldehydes, ketones, monocyclics, polycyclics, heterocyclics, monoterpenes, furans, pyrroles, pyrazines, azoles, carboxylic acids, benzenes, alkyl halides, alcohols, ethers, epoxides, esters, fatty acids and essential oils.

26. A composition as claimed in claim 24 wherein the carrier comprises one or more of the compounds listed in Table 1

27. A composition as claimed in claim 24 wherein the carrier has a molecular weight in the range of 100-700.

28. A composition as claimed in claim 1 wherein the fungal cell or fragment thereof is derived from one or more fungi selected from the group consisting of Mastigomycotina, Zygomycotina, Ascomycotina, Basidiomycotina and Deuteromycotina.

29. A composition as claimed in claim 28 wherein the fungal cell or a fragment thereof is derived from one or more fungi from Ascomycotina.

30. A composition as claimed in claim 1 wherein the fungal cell or a fragment thereof is derived from yeast.

31. A composition as claimed in claim 30 wherein the yeast is one or more yeast selected from the group consisting of Candida albicans, Blastomyces dermatitidis, Coccidioides immitis, Paracoccidioides brasiliensis, Penicillium marneffei and Saccharomyces cerevisiae.

32. A composition as claimed in claim 31 wherein the yeast is Saccharomyces cerevisiae.

33. A composition as claimed in claim 30 wherein the fungal cell or fragment thereof is derived from a biofuel yeast.

34. A composition as claimed in claim 1 wherein the adjuvant comprises a fungal cell which is alive or dead.

35. A composition as claimed in claim 1 wherein the composition is formulated into any one of the following: solutions, emulsions, suspensions, powders, foams, pastes, granules, aerosols, active-compound-impregnated natural and/or synthetic materials, polymeric substances, coating compositions for seed, formulations with smokes, fumigating cartridges, fumigating cans, fumigating coils, and also ULV cold mist and warm mist formulations.

36. An agrochemical composition comprising at least one lipid soluble phytoactive compound directed against a plant, and an encapsulating adjuvant, wherein the adjuvant comprises a fungal cell or fragment thereof.

37. A method of inhibiting weed growth or killing a weed in a growth medium comprising contacting the weed and/or growth medium with the composition of claim 36.

38. A method as claimed in claim 37 wherein said contacting is performed by spraying said composition on said weed and/or growth medium.

39. A method as claimed in claim 37 wherein the weed comprises one or more of the following:
Field Pansy (Viola avensis), Chickweed (Stellaria media), Field Bindweed (Convulvulus avensis), Fat Hen (Chenopodium album); volunteers from crops and weeds disclosed in tables 2 and 3.

40. A method as claimed in claim 37 wherein the growth medium comprises soil in a grow bag, a garden or a field.

41. A method of protecting a plant which comprises contacting the plant with the composition of claim 1.

42-44. (canceled)

45. A composition for the selective control of weeds in crops of cultivated plants, comprising a herbicidally effective amount of a herbicidal compound encapsulated within an adjuvant, wherein the adjuvant comprises a fungal cell or fragment thereof.

46. The composition as claimed in claim 8 wherein the ester of MCPA is MCPA-butoxyethyl [19480-43-4]; MCPA-butyl [1713-12-8]; MCPA-2-ethylhexyl [29450-45-1]; MCPA-isobutyl [1713-11-7]; MCPA-iso-octyl [26544-20-7]; MCPA-isopropyl [2698-40-0]; or MCPA-methyl [2436-73-9]; MCPA-thioethyl [25319-90-8].
